(19) United States
(12) Patent Application Publication
(10) Pub. No.: US 2010/0272092 A1
(43) Pub. Date: Oct. 28, 2010

(54) APPARATUS AND METHOD FOR BROADCASTING DATA, AND APPARATUS AND METHOD FOR BROADCASTING RESPONSE DATA, OF SENSOR NODE IN WIRELESS SENSOR NETWORK SYSTEM

(76) Inventors: Hoon Jeong, Daejeon-city (KR); Jong-Oh Lee, Daejeon-city (KR); Bong-Soo Kim, Daejeon-city (KR); Jong-Suk Chae, Daejeon-city (KR)

Correspondence Address: STAAS & HALSEY LLP, SUITE 700, 1201 NEW YORK AVENUE, N.W., WASHINGTON, DC, 20005, US

(21) Appl. No.: 12/745,747

(22) PCT Filed: Jul. 9, 2008
(86) PCT No.: PCT/KR2008/004022

§ 371 Date: Jun. 2, 2010

(30) Foreign Application Priority Data
Dec. 3, 2007 (KR) 10-2007-0124375

(51) Int. Cl. H04W 72/04

(52) U.S. Cl. 370/345

(57) ABSTRACT

Provided are an apparatus and method for broadcasting data, and an apparatus and method for broadcasting response data, of a sensor node in a beacon mode in a wireless sensor network system including a plurality of nodes. According to the apparatus and method for broadcasting data, an admission application message requesting an admission of a sensor node is transmitted to the wireless sensor network system, in which time-division time slots are assigned to each of the nodes of the wireless sensor network system, wherein, in the time-division time slot, the reception function of the node is activated and sensing data is transmitted; a beacon frame is received, which includes information that indicates a broadcasting time slot among the time-division time slots, wherein, in the broadcasting time slot, the reception function of each of the nodes of the wireless sensor network system having received the admission application message, is activated at the same time; and broadcasting data is transmitted during the broadcasting time slot. Accordingly, broadcasting data can be efficiently transmitted in a beacon mode of the wireless sensor network system.

### TECHNICAL FIELD

The present invention relates to an apparatus and method for broadcasting data, and an apparatus and method for broadcasting response data of a sensor node operating in a beacon mode in a wireless sensor network, and more particularly, to an apparatus and method for broadcasting data and an apparatus and method for broadcasting response data of a sensor node operating in a beacon mode, which increases energy efficiency in a wireless sensor network.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous Networking Technology].

### BACKGROUND ART

A wireless sensor network including a plurality of sensors scattered and distributed in all directions, is designed to sense and gather information generated in a predetermined region for various applications such as remote monitoring systems, remote medical treatment and unmanned exploration, etc. and send this information to a user using a wireless communication method.

Examples of such sensors include a thermometer, a hygrometer, a camera, or a microphone, and a sensor that measures a magnetic field. A sensor network is a collection of such sensors, including a wireless networking function that is added for the sensors to communicate with one another.

According to the IEEE 802.15.4 standard, devices constituting a wireless sensor network are classified into full function devices (FFD) supporting all functions of the IEEE 802.15.4 standard and reduced function devices (RFD) supporting some of the functions of the standard. The FFDs are classified into personal area network (PAN) coordinators controlling a PAN as a whole and routers controlling not the entire PAN but having child devices and controlling these.

Also, according to the IEEE 802.15.4 standard, a wireless sensor network system can be operated in a non-beacon enabled mode which is operated asynchronously, or in a beacon enabled mode in which synchronization between devices is maintained, and, accordingly, the reception function of the devices is activated or inactivated periodically to use limited resources efficiently.

### DISCLOSURE OF INVENTION

### Technical Problem

When operated in a non-beacon enabled mode, receivers of FFDs in the PAN are activated all the time, and receivers of the RFDs are activated only for a predetermined period of time and are inactivated otherwise, according to circumstances. In such a non-beacon enabled mode, as the reception function of the FFDs is activated all the time, there is no problem in broadcasting data to all peripheral devices.

However, in a beacon enabled mode, the FFDs in the PAN activates their reception function only in an incoming Superframe section for communicating with their parent device and in an outgoing Superframe section for communicating with their child device, and thus they cannot receive data that is transmitted by devices other than their parent device or child device. Thus, the process of transmitting data to all peripheral devices, that is, broadcasting, is complicated and time consuming.

### Technical Solution

The present invention provides an apparatus and method for transmitting broadcasting data of a sensor mode in a wireless sensor network system, in which a broadcasting time slot is defined among a plurality of time-division time slots, wherein, in the broadcasting time slot, the reception function of each of a plurality of nodes of the wireless network system is activated at the same time, and each node can transmit broadcasting data during the broadcasting time slot, thereby efficiently transmitting broadcasting data in a beacon mode in the wireless sensor network.

### Advantageous Effects

According to the present invention, broadcasting data can be transmitted with a shorter period of time through a simplified transmission process than in a beacon enabled mode of a conventional IEEE 802.15.4 standard.

Also, a response to the broadcasting data can be transmitted in a unicast manner, which is a relatively simple and quick method.

### DESCRIPTION OF DRAWINGS

The above and other features and advantages of the present invention will become more apparent by describing in detail exemplary embodiments thereof with reference to the attached drawings in which:

FIG. 1 is a schematic diagram of a frame in a beacon mode according to the IEEE 802.15.4 standard;

FIG. 2 is a schematic diagram of stratification of nodes of a wireless sensor network operated in a beacon mode based on a general IEEE 802.15.4 standard;

FIGS. 3A through 3C show data transmitting/receiving processes of the nodes of the wireless sensor network system illustrated in FIG. 2 operated in a beacon mode based on the IEEE 802.15.4 standard;

FIG. 4 is a block diagram of a broadcasting apparatus of a sensor node, according to an embodiment of the present invention;

FIG. 5 is a flowchart illustrating a broadcasting method of a sensor node, according to an embodiment of the present invention;

FIG. 6 is a schematic diagram illustrating a dedicated time slot and a broadcasting time slot assigned to a sensor node of a wireless network system, according to an embodiment of the present invention;

FIG. 7 is a schematic diagram for describing a process of transmitting broadcasting data during a broadcasting time slot, according to an embodiment of the present invention;

FIGS. 8A and 8B are schematic diagrams for describing a process in which a response to broadcasting data is transmitted in a unicast manner according to the IEEE 802.15.4 standard;

FIG. 9 is a block diagram of a broadcasting responding apparatus of a sensor node, according to an embodiment of the present invention;

FIG. 10 is a flowchart illustrating a method of broadcasting a response of a sensor node, according to an embodiment of the present invention;

FIG. 11A shows a format of data that is usually transmitted in a wireless sensor network system, according to an embodiment of the present invention;

FIG. 11B shows a format of broadcasting data according to an embodiment of the present invention; and

FIG. 12 is a schematic diagram for describing a process of transmitting response data using the apparatus and method illustrated in FIGS. 9 and 10, according to an embodiment of the present invention.

### BEST MODE

According to an aspect of the present invention, there is provided a broadcasting apparatus of a sensor node in a wireless sensor network system, in which time-division time slots are assigned to each of a plurality of nodes, wherein, in the time-division time slot, a reception function of each of the nodes is activated and sensing data is transmitted, the broadcasting apparatus comprising: an admission application message transmitting unit transmitting an admission application message requesting an admission of the sensor node, to the wireless sensor network system; a beacon frame receiving unit receiving a beacon frame comprising information that indicates a broadcasting time slot during which the reception function of each of the nodes of the wireless sensor network system having received the admission application message is activated at the same time; and a broadcasting unit transmitting broadcasting data during the broadcasting time slot.

According to another aspect of the present invention, there is provided a method of broadcasting data of a sensor node in a wireless sensor network system, in which a time-division time slot is assigned to each of a plurality of nodes, wherein, in the time-division time slot, the reception function of each of the nodes is activated and sensing data is transmitted, the method comprising: transmitting an admission application message requesting an admission of a sensor node, to the wireless sensor network system; receiving a beacon frame comprising information that indicates a broadcasting time slot among the time-division time slots, wherein, in the broadcasting time slot, the reception functions of each of the nodes of the wireless sensor network system having received the admission application message are activated; and broadcasting by transmitting broadcasting data during the broadcasting time slot.

According to another aspect of the present invention, there is provided a broadcasting responding apparatus of a sensor node in a wireless sensor network system, in which a time-division time slot is assigned to each of a plurality of nodes, wherein, in the time-division time slot, the reception function of the node is activated and sensing data is transmitted, the broadcasting responding apparatus comprising: a broadcasting receiving unit receiving broadcasting data that is broadcast by a neighbor node in the wireless sensor network system; a dedicated time slot extracting unit extracting a dedicated time slot during which the reception function of the neighbor node that has broadcast the broadcasting data is activated, from the received broadcasting data; and a broadcasting response transmitting unit transmitting a response to the received broadcasting data during the extracted dedicated time slot in a unicast manner.

According to another aspect of the present invention, there is provided a method of broadcasting response data of a sensor node in a wireless sensor network system, in which a time-division time slot is assigned to each of a plurality of nodes, wherein, in the time-division time slot, a reception function of the node is activated and sensing data is transmitted, the method comprising: receiving broadcasting data that is broadcast by a neighbor node in the wireless sensor network system; extracting a dedicated time slot, during which the reception function of the neighbor node having broadcast the broadcasting data is activated, from the received broadcasting data; and transmitting a response to the received broadcasting data during the extracted time slot in a unicast manner.

### MODE FOR INVENTION

The present invention will now be described more fully with reference to the accompanying drawings, in which exemplary embodiments of the invention are shown.

The following disclosure illustrates only the principles of the present invention. Therefore, those skilled in the art may embody this invention in many alternate forms which are not clarified or illustrated herein but realize the principles of the invention and fall within the concept and scope of the invention. Further, it shall be understood that, in principle, all conditional terms and embodiments used herein are clearly for the purpose of describing the concept of the invention to be understood only and are not intended to be limiting of the particular embodiments and conditions of the invention set forth herein. It shall be further understood that all detailed description of not only the principles, viewpoints and embodiments of the invention but also the particular embodiments are intended to cover the structural and functional equivalents thereof. It shall be further understood that the equivalents include not only those being open at present but also those to be developed in the future, that is, all devices to be invented to perform the same functions as the present invention, irrelevant to the structure of the invention.

Accordingly, the functions of various devices, which are illustrated in the accompanying drawings, including a processor or a functional block used in the concept being similar thereto, may be provided to be used for not only dedicated hardware but also hardware capable of running proper software. The functions provided by a processor may be provided by a single dedicated processor, a single shared processor, or a plurality of individual processors which may be partially shared. It shall be further understood that the terms used herein, such as ‘processor’, ‘control’ or the terms presented in the concept being similar thereto, should not be interpreted as excluding hardware which is capable of running software and will include, by implication, DSP (digital signal processor) hardware, ROM for storing software, RAM and nonvolatile memory. The terms may include any other well-known hardware.

The aforementioned objects, characteristics and advantages of the invention will be clearer in the detailed description with reference to the accompanying drawings. Where the functions and constitution are well-known in the relevant arts, further discussion will not be presented in the detailed description of the invention in order not to unnecessarily make the gist of the present invention unclear. Exemplary embodiments of the present invention will now be described more fully hereinafter with reference to the accompanying drawings.

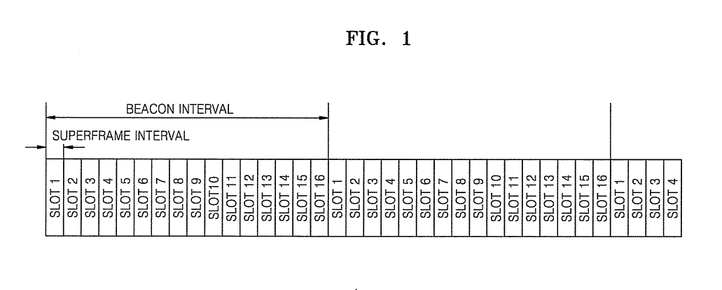

FIG. 1 is a schematic diagram of a beacon frame in a beacon mode according to the IEEE 802.15.4 standard.

Referring to FIG. 1, 16 time-division Superframe slots are included in one beacon interval.

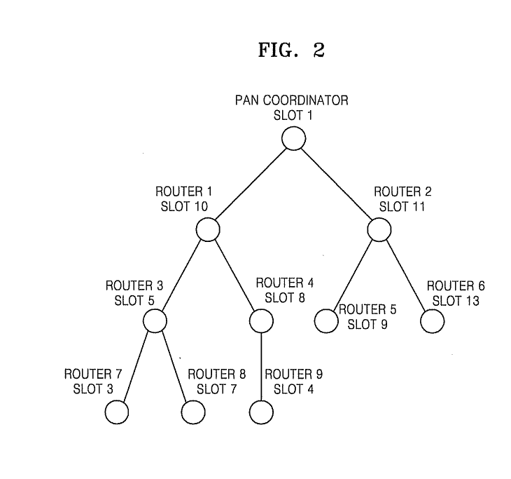

FIG. 2 is a schematic diagram of a stratification of nodes of a wireless sensor network system which is operated in a beacon mode having the frame of FIG. 1.

Referring to FIG. 2, each of the nodes, that is, a personal area network (PAN) coordinator and routers, is respectively assigned different Superframe slots from each other.

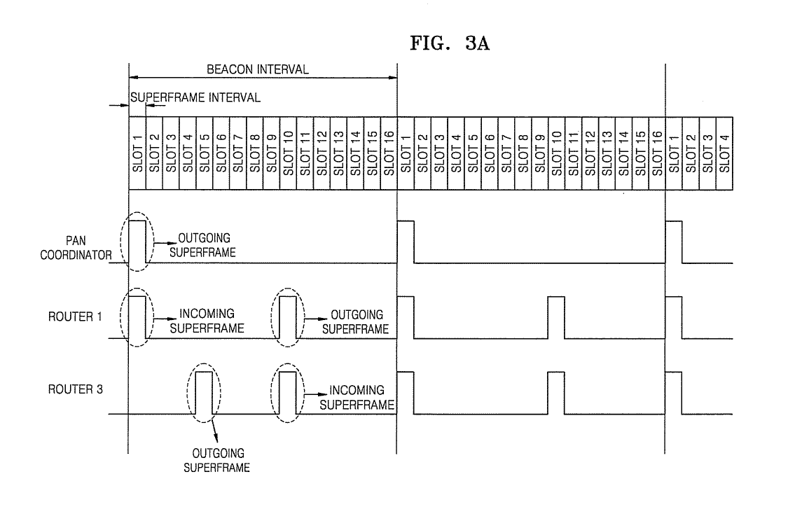

FIGS. 3A through 3C show data transmitting/receiving processes of the nodes of the wireless sensor network system illustrated in FIG. 2.

Referring to FIG. 3A, each of the nodes, that is, the PAN coordinator and the routers, has an incoming Superframe slot for communicating with its parent node, and an outgoing Superframe slot for communicating with its child nodes.

Referring to FIGS. 3B and 3C, the PAN coordinator is a route node at the top of the PAN, and thus has no parent node. Thus, the PAN coordinator only has a slot 1 as an outgoing Superframe slot for communicating with its child nodes.

In addition, a router 1 connected to the PAN coordinator as its child node has a slot 1 as an incoming Superframe slot for communicating with its parent node, the PAN coordinator, and a slot 10 as an outgoing Superframe slot for communicating with one of its child nodes, a router 3.

Also, the router 3 connected to the router 1 as a child node has a slot 10 as an incoming Superframe slot for communicating with its parent node, the router 1, and a slot 5 as an outgoing Superframe slot for communicating with its child nodes, routers 7 and 8.

Accordingly, to broadcast data to be transmitted to each of the nodes in the PAN from the PAN coordinator, broadcasting data that is transmitted from the PAN coordinator is transmitted via the slot 1 to the routers 1 and 2, and the router 1 transmits this data via the slot 10 to the router 3 and another router 4. Then, the router 3 transmits the data via the slot 5, which is its outgoing Superframe slot, to the routers 7 and 8.

As described above, in a beacon mode, transmission of broadcasting data is complicated, and furthermore, it takes a lot of time for the data that is broadcast to arrive at the end of the PAN.

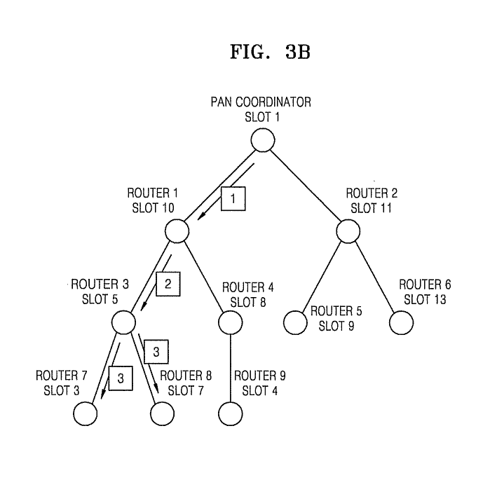

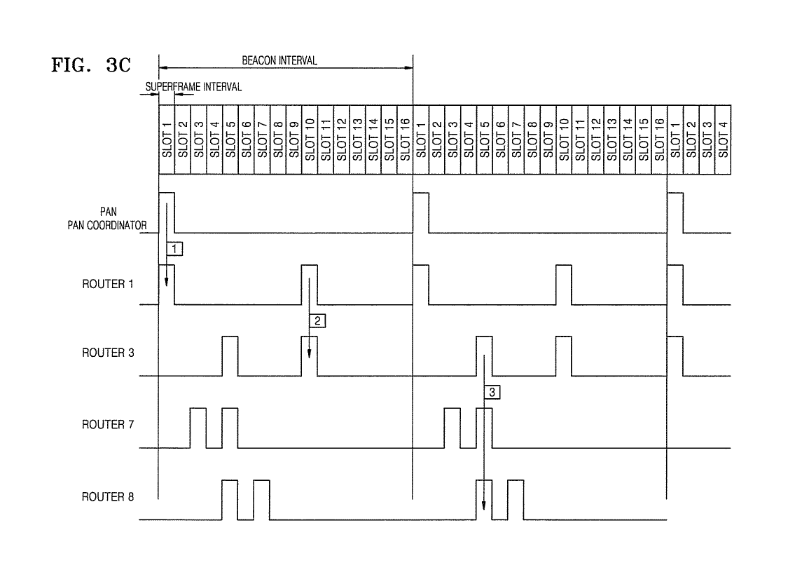

FIG. 4 is a block diagram of a broadcasting apparatus 402 of a sensor node 401 according to an embodiment of the present invention, and FIG. 5 is a flowchart illustrating a broadcasting method of the sensor node of FIG. 4, according to an embodiment of the present invention.

Referring to FIG. 4, the broadcasting apparatus 402 of the sensor node 401 according to the current embodiment includes an admission application message transmitting unit 410, a beacon frame receiving unit 420, and a broadcasting unit 430.

In operation S510, the admission application message transmitting unit 410 transmits an admission application message requesting the admission of the sensor node 401 to a wireless sensor network system 403, in which a time-division time slot is assigned to the sensor node 401, wherein a reception function of the sensor node 401 is activated during the time-division time slot and sensing data is transmitted.

When operated in a beacon mode of the IEEE 802.12.4 standard, the wireless sensor network system 403 has a frame in which a beacon interval is divided into a plurality of time-division time slots (Superframe slots), as illustrated in FIG. 1. Each of the nodes in the wireless sensor network system 403 activates its reception function during a Superframe slot that is assigned to the node, and transmits sensing data to another node in the wireless sensor network system 403.

The beacon frame receiving unit 420 receives a beacon frame including information which indicates a broadcasting time slot among the time-division slots, wherein, in the broadcasting time slot, the reception function of nodes of the wireless sensor network system 403 having received the admission application message is activated at the same time.

While the reception function of each of the nodes is activated in the wireless sensor network system 403 operated in a beacon mode based on the IEEE 802.15.4 standard during two Superframe slots—during an incoming Superframe slot (hereinafter referred to as an incoming time slot) for communicating with its parent node and during an outgoing Superframe slot (hereinafter referred to as an outgoing time slot) for communicating with its child nodes, as illustrated in FIG. 3A, according to the current embodiment of the present invention, the reception function of the nodes is also activated during a broadcasting time slot (broadcasting Superframe slot) besides the incoming time slot and the outgoing time slot. However, according to the current embodiment, it is not defined which slot is assigned as a broadcasting time slot for transmitting broadcasting data.

A beacon frame may further include information that indicates a dedicated time slot (a conventional Superframe slot) among the time-division time slots that is assigned to each of the nodes of the wireless sensor network system 403 and during which the reception function of each of the nodes is activated.

When a dedicated time slot is included in a beacon frame in addition to a broadcasting time slot, a dedicated time slot selection unit (not shown) may assign a dedicated time slot by selecting a dedicated time slot for the sensor node 401 among the time slots except the dedicated time slot and the broadcasting time slot. Also, the dedicated time slot may be assigned using other various methods, and the present invention is not limited to the current embodiment.

When the wireless sensor network system 403 has a tree structure as illustrated in FIG. 2, the sensor node 401 is assigned an incoming time slot for transmitting/receiving sensing data with its parent node and an outgoing time slot for transmitting/receiving sensing data with its child node assigned, as a dedicated time slot.

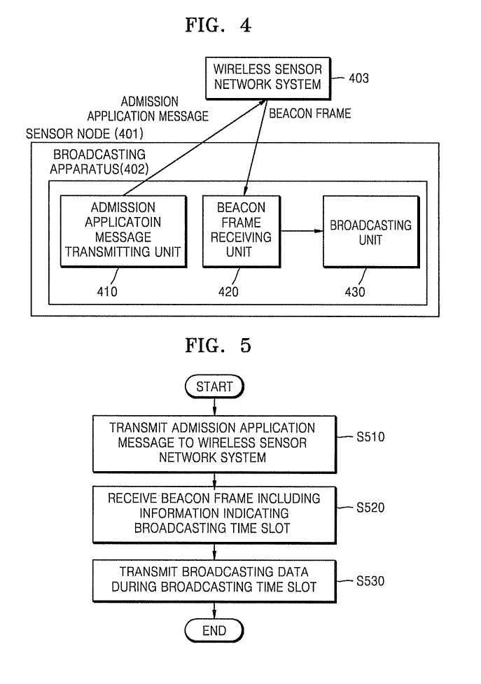

FIG. 6 is a schematic diagram illustrating a dedicated time slot and a broadcasting time slot assigned to a sensor node of a wireless network system, according to an embodiment of the present invention.

Referring to FIG. 6, a PAN coordinator has a slot 1 as an outgoing time slot, and a router 1 has the slot 1 as an incoming time slot and a slot 10 as an outgoing time slot, and a router 3 has a slot 10 as an incoming time slot and a slot 5 as an outgoing time slot.

The PAN coordinator, the router 1, the router 3, and the rest of a plurality of nodes of the wireless network system all are assigned a slot 16 as a broadcasting time slot. During the broadcasting time slot, all of the nodes of the wireless network system activate their reception function.

The broadcasting unit 430 transmits broadcasting data to be broadcast to all the rest of the nodes of the wireless sensor network system from a sensor node during a broadcasting time slot that is extracted from a beacon frame.

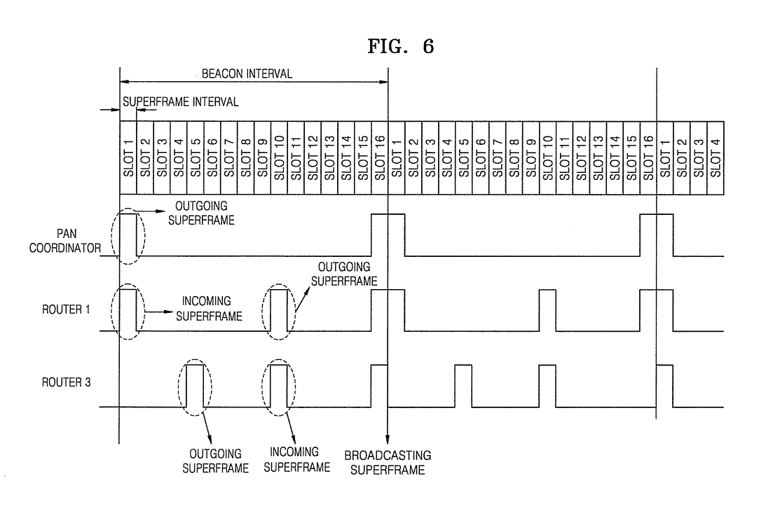

FIG. 7 is a schematic diagram for describing a process of broadcasting data transmission of a sensor node during a broadcasting time slot, according to an embodiment of the present invention.

Referring to FIG. 7, when the PAN coordinator transmits broadcasting data to be transmitted to each of a plurality of nodes in the PAN through a slot 16 that is designated as a broadcasting time slot, as the reception function of each of the nodes is activated during the broadcasting time slot, the broadcasting data is transmitted directly to routers 7 and 8 at the end of the PAN, without having to undergo a complicated process as illustrated in FIGS. 3A through 3C. Accordingly, broadcasting data can be transmitted using a simple and quick process.

Nevertheless, the above-described broadcasting method by assigning separate broadcasting time slots has a problem in that there might be data that requires a response to the broadcast data. In other words, in some cases, a node that has received broadcasting data must generate broadcasting response data in response to the broadcasting data and transmit the broadcasting response data in a unicast manner to the node that has transmitted the broadcasting data. However, in this case, the broadcasting time slot becomes too long to generate broadcasting response data and transmit it during the broadcasting time slot. Accordingly, the current embodiment of the present invention is realized such that no data other than the broadcasting data is transmitted during a broadcasting time slot. Consequently, broadcasting response data to be transmitted in a unicast manner that is generated as a response to the broadcasting data needs to be considered.

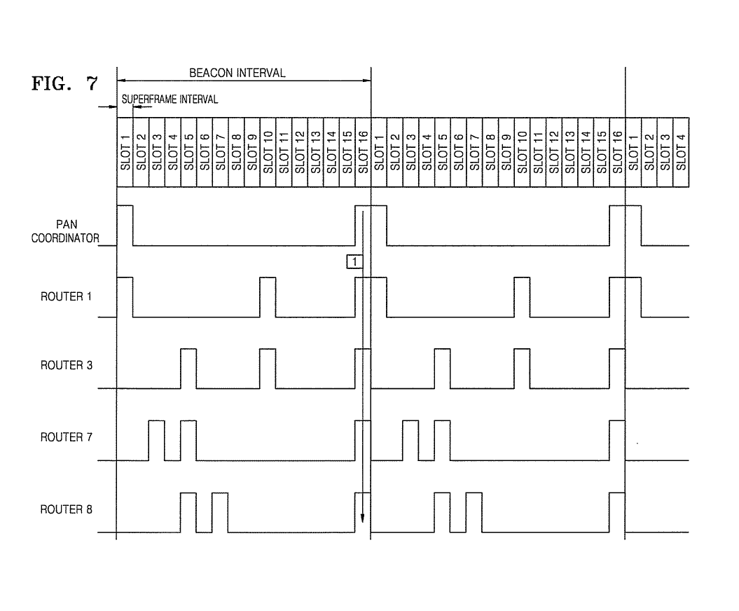

FIGS. 8A and 8B are schematic diagrams for describing a process in which a response to broadcasting data is transmitted in a unicast manner according to the IEEE 802.15.4 standard; FIG. 8A is a schematic diagram for describing a process of responding to the broadcasting data transmitted in the manner as illustrated in FIGS. 3A through 3C, and FIG. 8B is a schematic diagram for describing a process of responding to the broadcasting data that is transmitted according to the embodiment of the present invention as illustrated in FIGS. 4 and 5.

Referring to FIGS. 8A and 8B, response data to the broadcasting data is transmitted to a parent node, passing through other nodes, and finally to the node that has transmitted the broadcasting data. Data can be transmitted efficiently according to the broadcasting apparatus and method as illustrated in FIGS. 4 and 5, compared to the conventional IEEE 802.15.4 standard; however, in this case, also, the size of the PAN becomes large and the routing path is extended, creating a lot of delays.

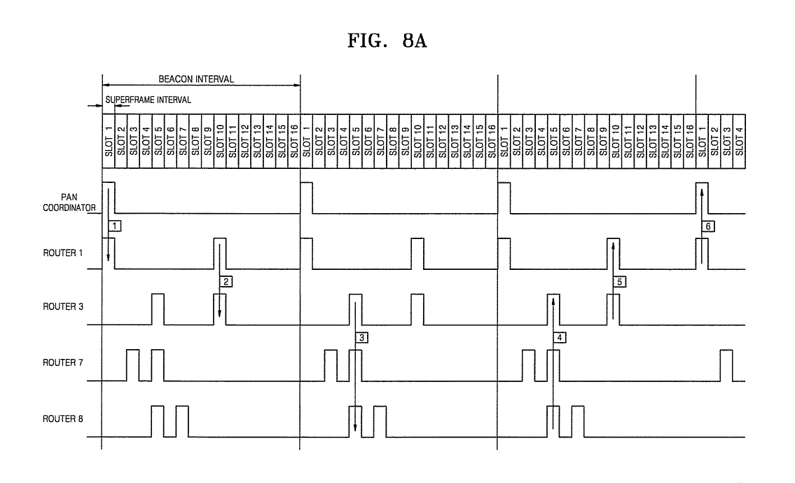

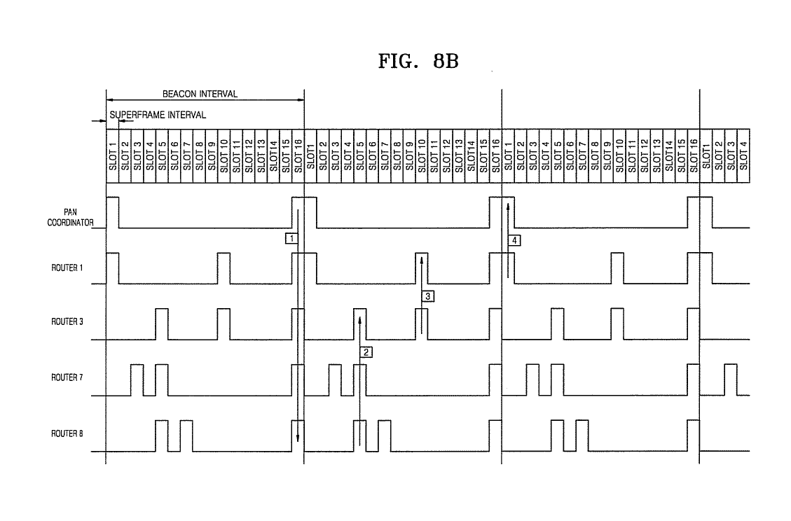

FIG. 9 is a block diagram of a broadcasting responding apparatus 902 of a sensor node 901, according to an embodiment of the present invention; and FIG. 10 is a flowchart illustrating a broadcasting responding method of the broadcasting responding apparatus 902 of FIG. 4, according to an embodiment of the present invention.

Referring to FIG. 9, the broadcasting responding apparatus 902 of the sensor node 901 according to the current embodiment includes a broadcasting receiving unit 910, a dedicated time slot extracting unit 920, and a broadcasting response transmitting unit 930.

The broadcasting receiving unit 910 receives the broadcasting data that is broadcast by a neighbor node 903 in the wireless sensor network system in operation S1010.

When the embodiment of FIGS. 4 and 5 is applied, the broadcasting receiving unit 910 receives broadcasting data of a broadcasting time slot during which the reception function of each of a plurality of nodes of the wireless sensor network is activated at the same time.

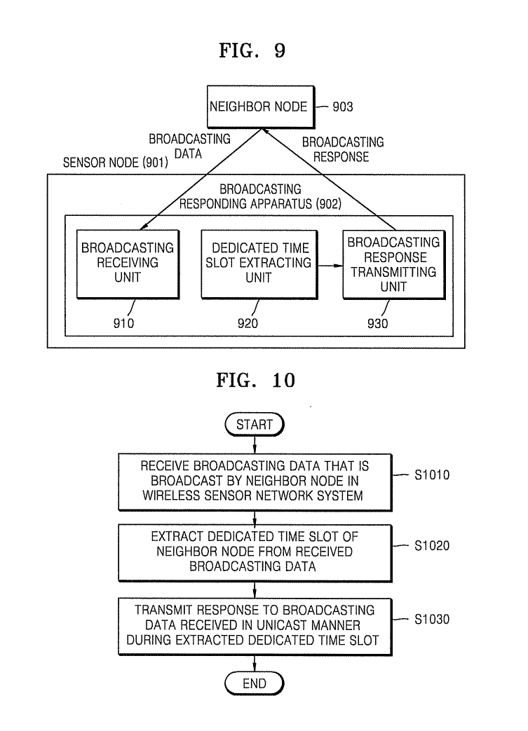

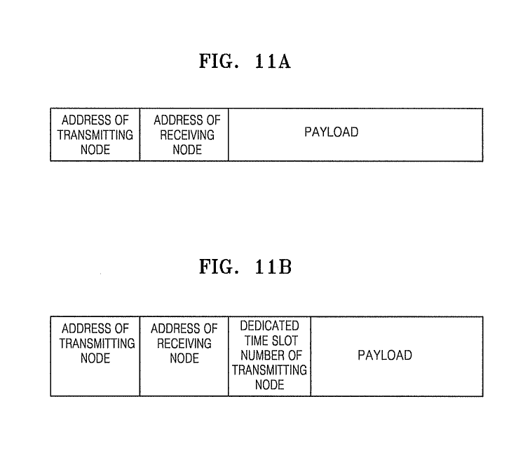

FIGS. 11A and 11B show formats of broadcasting data; FIG. 11A shows data that is usually transmitted in a wireless sensor network system, and FIG. 11B shows broadcasting data according to an embodiment of the present invention.

Referring to FIGS. 11A and 11B, the broadcasting data according to the current embodiment of the present invention includes additional information that indicates a dedicated time slot which is assigned to a sensor node transmitting broadcasting data and during which the reception function of the sensor node is activated, for example, an outgoing slot number of a sensor node, in addition to information that is included in a frame of data that is usually transmitted.

The dedicated time slot extracting unit 920 extracts a dedicated time slot during which the reception function of a neighbor node 903 having broadcast broadcasting data is activated, from the broadcasting data received by the broadcasting receiving unit 910 in operation S1020.

The broadcasting response transmitting unit 930 transmits a response to the broadcasting data received by the broadcasting receiving unit 910 during the dedicated time slot extracted in a dedicated time slot extracting unit, to the neighbor node 903 in a unicast manner in operation S1030.

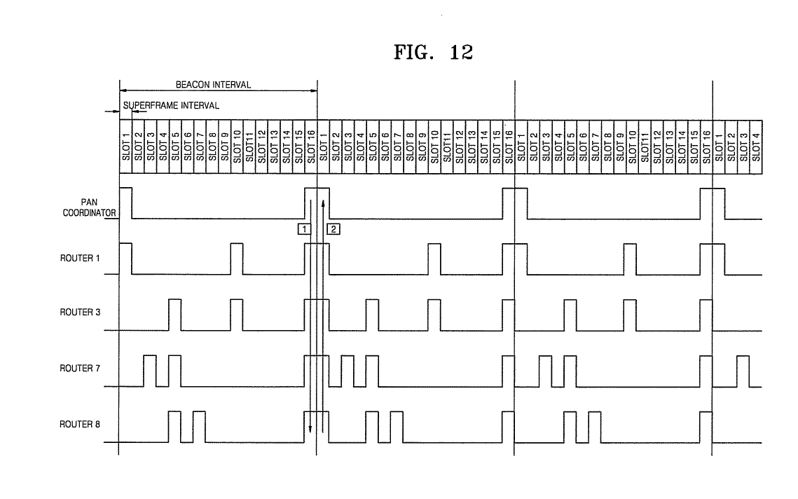

FIG. 12 is a schematic diagram for describing a process of broadcasting response data using the apparatus and method illustrated in FIGS. 9 and 10, according to an embodiment of the present invention.

Referring to FIG. 12, according to the apparatus and method for broadcasting response data according to the current embodiment of the present invention, a response to broadcasting data can be transmitted in a unicast manner during a dedicated time slot of the sensor node that has transmitted broadcasting data. Thus, the response to the broadcasting data can be transmitted in a relatively simple and quick fashion.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, a font ROM data structure according to the present invention can be embodied as computer readable codes for recording media such as computer readable ROM, RAM, CD-ROM, magnetic tapes, hard disks, floppy disks, flash memories, optical data storage devices, etc.

While the present invention has been particularly shown and described with reference to exemplary embodiments thereof, the exemplary embodiments should be considered in descriptive sense only and not for purposes of limitation. Thus it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

1. A broadcasting apparatus of a sensor node in a wireless sensor network system, in which time-division time slots are assigned to each of a plurality of nodes, wherein, in the time-division time slot, a reception function of each of the nodes is activated and sensing data is transmitted, the broadcasting apparatus comprising:
an admission application message transmitting unit transmitting an admission application message requesting an admission of the sensor node, to the wireless sensor network system;
a beacon frame receiving unit receiving a beacon frame comprising information that indicates a broadcasting time slot during which the reception function of each of the nodes of the wireless sensor network system having received the admission application message is activated at the same time; and
a broadcasting unit transmitting broadcasting data during the broadcasting time slot.

2. The apparatus of claim 1, wherein the wireless sensor network system is operated in a beacon mode of the IEEE 802.15.4 standard.

3. The apparatus of claim 1, wherein the beacon frame further comprises information that indicates a dedicated time slot among the plurality of time-division time slots, which is assigned to each of the nodes of the wireless sensor network system and the reception function of each of the nodes is activated.

4. The apparatus of claim 3, further comprising a dedicated time slot selection unit selecting a dedicated time slot of the sensor node among the time-division time slots except the dedicated time slot and the broadcasting time slot.

5. The apparatus of claim 3, wherein the wireless sensor network system comprises a tree network, and
the dedicated time slot comprises an incoming time slot transmitting/receiving sensing data between a node to which the dedicated time slot is assigned and a parent node of the assigned node and an outgoing time slot transmitting/receiving sensing data between the assigned node and a child node of the assigned node.

6. The apparatus of claim 1, wherein the broadcasting data comprises information that indicates a dedicated time slot which is assigned to the sensor node among the time-division time slots and during which the reception function of the sensor node is activated.

7. A method of broadcasting data of a sensor node in a wireless sensor network system, in which a time-division time slot is assigned to each of a plurality of nodes, wherein, in the time-division time slot, the reception function of each of the nodes is activated and sensing data is transmitted, the method comprising:
transmitting an admission application message requesting an admission of a sensor node, to the wireless sensor network system;
receiving a beacon frame comprising information that indicates a broadcasting time slot among the time-division time slots, wherein, in the broadcasting time slot, the reception functions of each of the nodes of the wireless sensor network system having received the admission application message are activated; and
broadcasting by transmitting broadcasting data during the broadcasting time slot.

8. The method of claim 7, wherein the wireless sensor network system is operated in a beacon mode according to the IEEE 802.15.4 standard.

9. The method of claim 7, wherein the beacon frame further comprises information that indicates a dedicated time slot among the time-division time slots, which is assigned to each of the nodes of the wireless sensor network system and during which the reception function of each of the nodes is activated.

10. The method of claim 9, further comprising selecting a dedicated time slot of the sensor node, among time slots except the dedicated time slot and the broadcasting time slot.

11. The method of claim 9, wherein the wireless sensor network system is a tree network, and the dedicated time slot comprises an incoming time slot transmitting/receiving sensing data between a node to which the dedicated time slot is assigned and a parent node of the assigned node and an outgoing time slot transmitting/receiving sensing data between the assigned node and a child node of the assigned node.

12. The method of claim 7, wherein the broadcasting data comprises information that indicates a dedicated time slot which is assigned to the sensor node among the time-division time slots and during which the reception function of the sensor node is activated.

13. A broadcasting responding apparatus of a sensor node in a wireless sensor network system, in which a time-division time slot is assigned to each of a plurality of nodes, wherein, in the time-division time slot, the reception function of the node is activated and sensing data is transmitted, the broadcasting responding apparatus comprising:
a broadcasting receiving unit receiving broadcasting data that is broadcast by a neighbor node in the wireless sensor network system;
a dedicated time slot extracting unit extracting a dedicated time slot during which the reception function of the neighbor node that has broadcast the broadcasting data is activated, from the received broadcasting data; and
a broadcasting response transmitting unit transmitting a response to the received broadcasting data during the extracted dedicated time slot in a unicast manner.

14. The apparatus of claim 13, wherein the broadcasting receiving unit receives broadcasting data during a broadcasting time slot during which the reception function of each of the nodes in the wireless network system is activated at the same time.

15. A method of broadcasting response data of a sensor node in a wireless sensor network system, in which a time-division time slot is assigned to each of a plurality of nodes, wherein, in the time-division time slot, a reception function of the node is activated and sensing data is transmitted, the method comprising:
receiving broadcasting data that is broadcast by a neighbor node in the wireless sensor network system;
extracting a dedicated time slot, during which the reception function of the neighbor node having broadcast the broadcasting data is activated, from the received broadcasting data; and
transmitting a response to the received broadcasting data during the extracted time slot in a unicast manner.

16. The method of claim 15, wherein, in the receiving broadcasting data, broadcasting data is received during a broadcasting time slot in which the reception function of each of the nodes in the wireless network system is activated at the same time.
